(19) United States
(12) Patent Application Publication
(10) Pub. No.: US 2013/0192410 A1
(43) Pub. Date: Aug. 1, 2013

(54) SAFETY ARRANGEMENT

(71) Applicant: Johan Hoffmann, Bastad (SE)

(72) Inventor: Johan Hoffmann, Bastad (SE)

(73) Assignee: JOHRIA INNOVATION AB, Bastad (SE)

(21) Appl. No.: 13/878,039

(22) PCT Filed: Oct. 4, 2011
(86) PCT No.: PCT/SE2011/051179

§ 371 Date: Apr. 5, 2013

(30) Foreign Application Priority Data
Oct. 5, 2010 (SE) 1051042-8

(51) Int. Cl. G05G 5/00

(52) U.S. Cl. CPC G05G 5/00
USPC 74/526

(57) ABSTRACT

A safety arrangement for a device such as a baby carriage, wheelchair or the like, having an actuator apparatus including first and second relatively displaceable parts movable between a first and second position. When the first part is arranged, in the first position it actuates a brake, and in the second position causing the brake to be in a non-braking state. The actuator is arranged, in the absence of external influence, to adopt the first position. A locking member is releasably attachable to the actuator for locking the first part in the second position, and unlocking of the first part in the second position upon application of a force. The first part is rotatable relative to the second part about a axis for displacement between the first and the second position, and includes a retaining mechanism arranged to connect the locking member to the actuator.

### TECHNICAL FIELD

The invention relates to a safety arrangement for a device such as a baby carriage, a wheelchair or the like. The safety arrangement comprises an actuating means having a first and a second part and a releasably attached locking means. The first and the second part are displaceable relative to one another and can adopt a first and a second position, in which first position the actuating means actuates a brake arrangement in such a way that it is in a braking state. The locking means can lock the actuating means in the second position of the first part, in which the actuating means is in a non-braking state.

### BACKGROUND OF THE INVENTION

Baby carriages, wheelchairs and similar carriages are often equipped with a brake, by means of which the carriage can be braked when in its stationary position. In most cases, however, baby carriages and wheelchairs are not equipped with any brake capable of braking the carriage in the event of the person pushing the carriage losing control over it. For example, the carriage may roll away uncontrollably if the person pushing the carriage falls, or if a person stops the carriage on an uneven surface and fails to notice that the carriage is rolling away. This can give rise to danger for the child or the person sitting in the carriage or the wheelchair.

One solution is to provide the carriage with a so-called dead man's handle, that is to say a handle which must be kept depressed to ensure that the brake does not adopt its locked position. In the long run, however, it may be demanding to have to keep a handle constantly depressed in order for the carriage to be free to move.

One solution which reduces the disadvantages associated with a dead man's handle is described in GB 1 377 168. This document describes a brake for a baby carriage having a brake handle mounted on the handle of the baby carriage. A clamp can be secured around the brake handle so that it is kept depressed in the position in which the brakes are not applied. A strap is attached at one end to the clamp, and its other end is passed around the wrist of the person pushing the carriage. If the person pushing the carriage were to fall, the person will pull on the strap, thereby causing the clamp to be released from the brake handle and causing the brakes to be applied.

Another similar solution is described in SE 522 740. Described in this document is a safety arrangement, in which a collar device bears against a spacer. When the collar device is kept held up by the distance piece, the safety arrangement is in a non-braking state. Arranged in the distance piece is a strap, which at its other end is attached to the person pushing the baby carriage. If this person were to fall, for example, or if the carriage were to roll uncontrollably down an incline, the person will pull on the strap, thereby causing the spacer to be released from the safety arrangement and the collar device to drop down and apply the brake.

In the solutions described above, a safety arrangement for braking the baby carriage is activated when a user actuates a locking device in the form of a clamp and a spacer, respectively, with sufficiently great force.

### SUMMARY OF THE INVENTION

In the light of the above, one object of the present invention is to provide an improved safety arrangement for a device such as a baby carriage, a wheelchair or the like.

More precisely, a safety arrangement comprising an actuating means comprising a first part and a second part, the first part being displaceable relative to the second part between a first position and a second position, is provided for a device such as a baby carriage or a wheelchair. The actuating means is arranged, in the first position of the first part, to actuate a brake arrangement so that it is in a braking state, the actuating means, in the second position of the first part, being arranged to actuate the brake arrangement so that it is in a non-braking state. The first part is arranged, in absence of external influence, to adopt the first position. The safety arrangement further comprises a locking means being releasably attachable to the actuating means for locking the first part in the second position, the locking means being arranged to cease said locking of the first part in the second position by application of a predetermined force. The first part is rotatable relative to the second part about a geometrical axis for displacement between the first and the second position. The actuating means includes a retaining means which is arranged, upon releasable attachment of the locking means to the actuating means, to connect the locking means to the actuating means, the retaining means being arranged, by application of said predetermined force, to maintain the connection of the locking means to the actuating means until the first part has adopted the first position and then to release the locking means from the actuating means.

The application of a predetermined force denotes the actuation of the locking means with a force exceeding a predetermined threshold value and in a predetermined direction.

One advantage of the present invention is that the locking means ceases its locking of the first part in the second position by application of a predetermined force. A person, referred to below as the person pushing, pushes the device, such as a baby carriage or wheelchair, also referred to below as the carriage, can be caused to actuate the locking means with a force if the person pushing falls, stumbles, loses control of the carriage on a slope or stairway, etc., by connecting the person pushing the carriage to the locking means with a strap or the like. As a result of this, the first part returns to the first position, in which the actuating means actuates the brake arrangement so that it adopts its braking position. A person pushing who loses control of a carriage equipped with the safety arrangement according to the invention actuates the locking means with a predetermined force, for example by falling or stumbling or by the carriage running away on a downhill slope or down a flight of stairs. When the locking means is actuated by a predetermined force, locking of the first part in the second position ceases and the first part instead adopts its first position. In this first position, the actuating means actuates the brake arrangement so that it adopts its braking position. The carriage will thereby be braked. This prevents the carriage from running away in a situation, in which the person pushing no longer has control of the carriage. If, for example, the person pushing tumbles down a steep downhill slope, the carriage will not continue to run away but will be braked by the safety arrangement. In a situation, in which the person pushing leaves the carriage in the belief that the carriage will remain stationary, but it begins to roll because of the inclined nature of the surface, the safety arrangement will brake the carriage and prevent its movement.

Another advantage of the safety arrangement is that it offers extra security. In the event that the safety arrangement has been subjected to an influence such as an accident, wear or a manufacturing fault, which means that the first part is unable to reach its first position, the person pushing will not be released from the carriage. The retaining means maintains the connection between the locking means and the actuating means until the first part has adopted its first position. Once the first part has adopted its first position, in which the brake arrangement is in its braking state, the locking means is released from the retaining device. In this way, the person pushing is not released from the safety arrangement until the brake arrangement brakes the carriage. In the event that the first part does not adopt its first position, the person pushing will still be connected to the carriage and will thus have the opportunity to stop the carriage. This prevents a situation in which the safety arrangement fails to activate the brakes at the same time as the person pushing completely loses control of the carriage.

A further advantage is that the safety arrangement exhibits a simple construction comprising few parts, this being advantageous from the point of view of manufacturing and costs. The safety arrangement is also easy to retrofit to a carriage which lacks any such safety arrangement.

The second part may comprise a section which is situated radially externally relative to the first part. The locking means is thus capable of being passed through said section and into contact with the first part to permit its releasable attachment to the actuating means. The second part thus guides the locking means into engagement with the actuating means.

The locking means may be arranged to engage with the first part for locking the first part in the second position.

The retaining means may comprise a projection arranged to engage with the locking means. The projection may engage with a recess in the locking means.

The retaining means may be resilient. This allows the locking means to be moved out of its engagement with the actuating means, for example by the person pushing the carriage pulling on the locking means, so that locking of the first part can cease. Maintenance of the connection of the retaining means to the locking means is permitted at the same time.

The retaining means may be arranged for guiding the locking means for locking the first part in the second position. It is sufficient for the person pushing to introduce the locking means into the actuating means so that the retaining means engages with the locking means. The retaining means then guides the locking means into engagement with the first part.

The first part may comprise a step arranged to engage with the locking means for locking the first part in the second position. The interaction of the locking means with the step locks the first part in the second position by preventing rotation of the first part.

The locking means may comprise a pin arranged to engage with a recess in the actuating means for locking the first part in the second position. The person pushing can be connected to the pin by means of a strap so that, when the user pulls on the pin, locking of the first part in the second position ceases.

The retaining means may be formed by a groove which is defined by the first and the second part. The engagement of the locking means with the actuating means will be maintained for as long as the locking means is inserted into the groove.

The pin may be arranged, by application of said predetermined force, to cease its engagement with the recess in the actuating means.

The safety arrangement may also comprise a strap arranged to be connected to the locking means and the person pushing the device. The person pushing may have the strap secured around his/her wrist or to his/her belt, for example. In the event of the person pushing losing control of the baby carriage, the person pushing will actuate the strap, as a result of which the locking means will be pulled automatically out of its engagement with the first part.

The locking means may be insertable into the actuating means in a radial direction.

Said predetermined force, the level of which may exceed a predetermined threshold value, may be oriented in a radial direction away from the actuating means.

One or other of the first and the second parts may comprise a handle part which is rotatable about said geometrical axis in order to bring the actuating means to the second position of the first part. The handle part facilitates rotation of the first part to its second position.

The safety arrangement may also comprise a wire connected to the actuating means and the brake arrangement.

The actuating means may be actuated by a spring force in order to cause the first part, in the absence of external influence, to adopt the first position.

The first part may be displaceable relative to the second part between said first position, said second position and a third position, the actuating means in the third position of the first part being arranged to actuate said brake arrangement or an additional brake arrangement so that the brake arrangement is in a braking state. The safety arrangement in the third position thus functions as a conventional handbrake for braking the baby carriage, for example on downhill slopes. The safety arrangement thus provides a further function. In the third position, the safety arrangement functions as a handbrake for use when pushing the baby carriage along.

The first, second and third positions may be arranged as to follow one after the other in a continuous rotational movement.

A baby carriage comprising a safety arrangement is provided according to another aspect of the invention. The advantages described above are also applicable to this aspect of the invention.

### BRIEF DESCRIPTION OF THE DRAWINGS

Embodiments of the present invention are described below by way of illustration with reference to the accompanying drawings.

FIG. 1 depicts a baby carriage chassis comprising a safety arrangement.

FIG. 2 depicts schematically a safety arrangement according to a first embodiment of the present invention, in which a first part is in a first position.

FIG. 3 depicts schematically the safety arrangement in FIG. 2, in which the first part is in a position between the first and the second position.

FIG. 4 depicts schematically the safety arrangement in FIG. 2, in which the first part is in a second position.

FIG. 5 depicts schematically the safety arrangement in FIG. 2, in which the first part is in a position between the second and the first position.

FIG. 6 depicts schematically the safety arrangement in FIG. 2, in which the first part is again in the first position.

FIG. 7 depicts schematically the safety arrangement in FIG. 2, which has once again reached the starting position.

FIG. 8 depicts a safety arrangement according to a second embodiment of the present invention.

FIGS. 9 and 10 depict the locking means in more detail.

FIG. 11 depicts schematically the safety arrangement in FIG. 8, in which the first part is in a first position.

FIG. 12 depicts schematically the safety arrangement in FIG. 8, in which the locking means has been introduced into a groove in the actuating means.

FIG. 13 depicts schematically the safety arrangement in FIG. 8, in which the first part is in a second position.

FIG. 14 depicts schematically the safety arrangement in FIG. 8, in which the first part is again in the first position.

FIG. 15 depicts schematically a safety device according to a third embodiment of the present invention.

FIG. 16 depicts schematically the safety arrangement in FIG. 15, in which the first part is in a third position.

FIG. 17 depicts schematically a device without a locking means.

### DETAILED DESCRIPTION

Embodiments of a safety arrangement 1 according to the present invention are described below in conjunction with their use on a baby carriage 2.

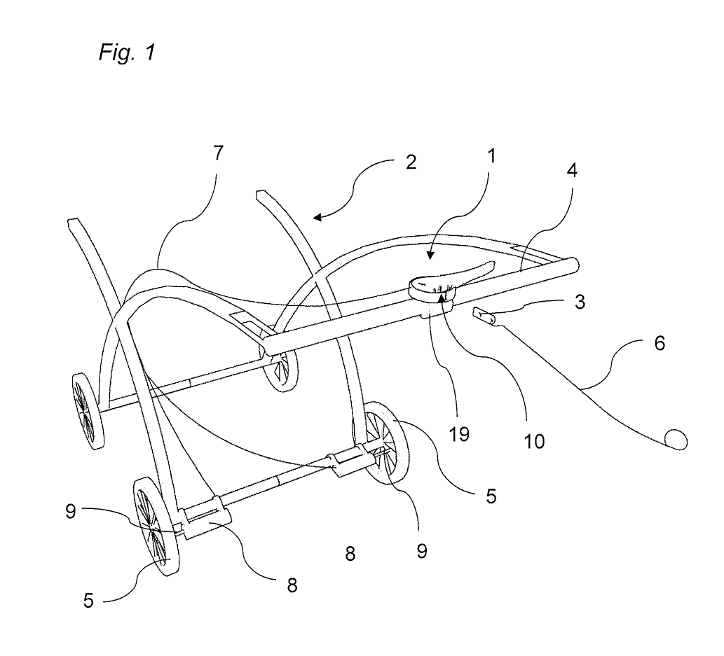

Depicted schematically in FIG. 1 is a chassis for a baby carriage 2 having a safety arrangement 1 according to a first embodiment. The depicted baby carriage 2 has four wheels 5, although it can also have three or any other number of wheels. The safety arrangement 1 comprises an actuating means 10 and a locking means 3. The actuating means 10 is mounted on a handle part 4 of the baby carriage 2. The actuating means 10 is appropriately positioned so that it is easy for the person pushing to reach. The expression person pushing is used below to denote a person who pushes along the baby carriage, the wheelchair or a similar device provided with the safety arrangement 1. A strap 6 is connected to the locking means 3. The person pushing can be connected to the strap 6. The strap 6 can be terminated with a loop, for example, that the person pushing places around his/her wrist. Alternatively, a hook can be arranged at the free end of the strap 6. The hook can be attached to the person pushing, for example to his/her belt.

The baby carriage 2 is provided with a brake arrangement 8. Arranged between the actuating means 10 and the brake arrangement 8 is a wire 7. In the illustrated embodiment, the brake arrangement 8 comprises two brake elements 8, one brake element 8 on one rear wheel 5 and one brake element 8 on the other rear wheel 5. A person skilled in the art will appreciate that the invention can be realized with a single brake element, and that the brake element can be arranged alternatively on another wheel, for example on a front wheel. Each brake element in the depicted example consists of a pin 9 which is pushed into the wheel 5 between its spokes in order to prevent rotation of the wheel 5 by braking. A person skilled in the art will appreciate that the braking effect can be achieved in a variety of different ways, for example by means of a disc brake, a drum brake or brake blocks which act upon the wheel or the wheel axle, or with a magnetic brake.

As an alternative, instead of the wire 7, the brake arrangement 8 can be controlled by the electric transmission of a signal.

The actuating means 10 can adopt two positions, one position in which the actuating means 10 actuates the brake arrangement 8 so that it is in a braking state, and a second position in which the actuating means 10 actuates the brake arrangement 8 so that it is in a non-braking state. In the absence of external influence, the actuating means 10 will attempt to adopt the first position, that is to say the position, in which the brake arrangement 8 brakes the baby carriage 2.

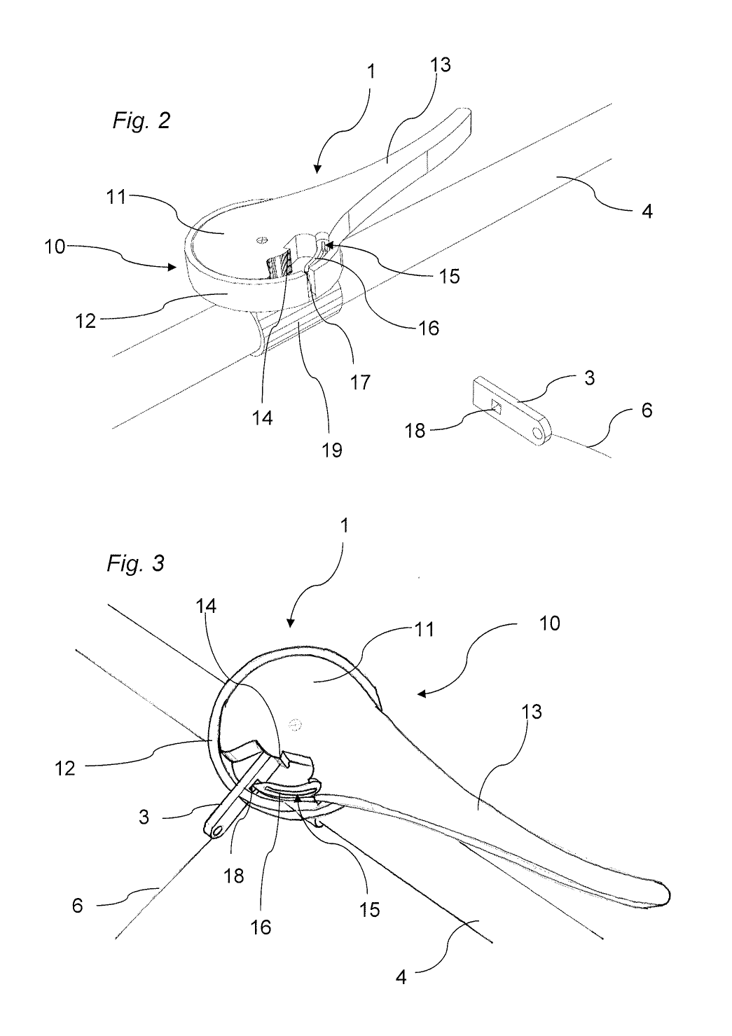

A first embodiment of the safety arrangement 1 is now described in more detail with reference to FIGS. 1 and 2. The actuating means 10 of the safety arrangement 1 comprises a first part 11 in the form of a handle and a second part 12 in the form of a seat for a base of the handle. The first part 11 is displaceable relative to the second part 12 between a first and a second position. More precisely, the first part 11 is rotatable relative to the second part 12 about a geometrical axis for displacement between the first and the second position. The actuating means 10, in the first position of the first part, actuates the brake arrangement 8 via said wire 7 (not depicted in FIG. 2) so that it is in a braking state. In the second position of the first part, the actuating means 10 actuates the brake arrangement 8 so that it is in a non-braking state. The wire 7 can be spring-loaded. The first part 11 attempts to adopt the first position in the absence of external influence. For example, the actuating means 10 can be spring-loaded so that the first part attempts to adopt the first position.

In the depicted embodiment, the second part 12 exhibits a section which is situated radially externally relative to the first part. The second part 12 thus at least partially encloses the first part 11.

The first part 11 is also provided with a handle part 13. The handle part 13 extends radially outwards from the first part 11 through an opening in the section of the second part 12. The handle 13 is so arranged as to facilitate rotation of the first part 11 from the first position to the second position. A person skilled in the art will appreciate that the handle part can be configured in many different ways. For example, the handle part can be in the form of a knob.

The first part 11 also comprises a step 14, the function of which will be described below. In the depicted embodiment, the first part 11 comprises a retaining means 15. In the depicted embodiment, the retaining means 15 is in the form of a projection 16. The projection 16 extends in the circumferential direction, but it may have a different radius than the first part 11. The projection 16 is resilient, for example as a result of the removal of material from the projection. The retaining means 15 may be made of plastic or metal.

The second part 12 is provided with a recess 17, through which the locking means 3 can be inserted into the actuating means 10. The second part 12 can also be provided with fixing means 19 for attachment of the actuating means 10 to the baby carriage 2.

The locking means 3 is provided with a recess 18. The recess 18 is intended to receive the retaining means 15 when the locking means 3 is inserted into the actuating means 10. Attached to one end of the locking means 3 is a strap 6, which strap 6 is intended to be attached to the person pushing. The other end of the locking means 3 is intended to engage with the step 14 on the first part 11 when the locking means 3 is inserted into the actuating means 10.

The first part 11 and the second part 12 may be made of plastic. The handle part 13 and the locking means 3 may also be made of plastic.

In FIGS. 1 and 2, the actuating means 10 is in its first position, in which the actuating means 10 actuates the brake arrangement 8 so that it is in the braking state. The baby carriage 2 is braked in this way.

In FIG. 3, to which reference is now made, displacement of the first part 11 begins by rotation from the first position to the second position. The rotating movement takes place in a clockwise direction in the depicted embodiment. The person pushing now wishes to move the baby carriage forwards and must release the brake arrangement 8 in order to do this. The person pushing takes hold of the handle part 13 and rotates the first part 11 of the actuating means 10 towards the second position. The person pushing must then overcome the force which causes the first part 11 to attempt to adopt the first position.

The locking means 3 is insertable into the locking means 10, for example in a radial direction. Before or in conjunction with the commencement of the displacement through rotation, the locking means 3 is inserted into the actuating means 10 through the recess 17 in the second part 12. The actuating means 10 can also be provided with guide elements, for example in the form of steps, for guiding the locking means 3 into the actuating means 10 in the right direction. When the rotating movement commences, the first part 11 comes into a position in which the retaining means 15 engages with the recess 18 in the locking means 3. In the case where the retaining means 15 is a projection 16 arranged on the first part 11, the projection is moved into the recess 18 of the locking means 3. In one embodiment, the projection 16 is configured in such a way that the rotating movement causes the projection 16 to guide the locking means 3 further in towards the centre of the first part 11 for engagement with the first part 11.

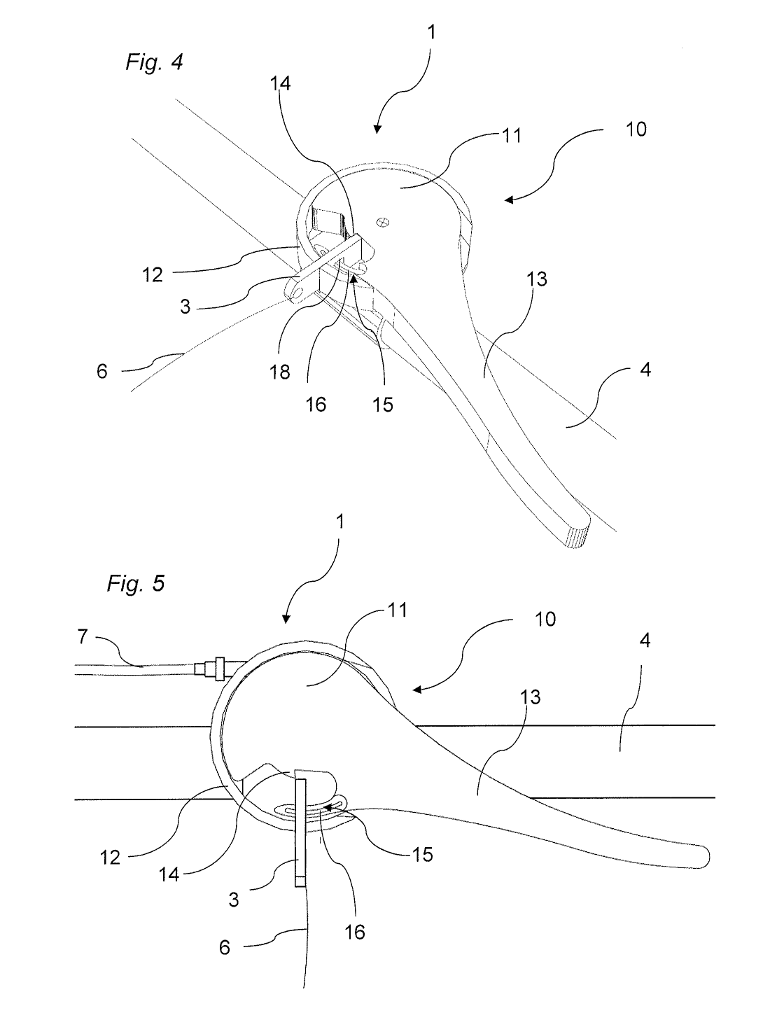

Further rotation of the first part 11 towards the second position will cause the resilient retaining means 15 to press an end surface of the locking means 3 towards a guide surface on the first part 11. Said step 14 is formed on said guide surface and, once the first part 11 has reached the second position, the end surface of the locking means 3 will have passed said step 14, as depicted in FIG. 4. In this second position, the engagement of the locking means 3 with the step 14 counteracts the attempt by the first part 11 to adopt the first position. The locking means 3 thus locks the first part 11 in the second position, in which the brake arrangement 8 adopts its non-braking position. The baby carriage 2 is thus able to roll freely without the person pushing being required to take hold of the handle part 13 in order to release the brake arrangement 8.

FIG. 5 depicts a situation, in which the person pushing actuates the locking means 3 with a predetermined force, for example as the result of losing control of the baby carriage 2 for some reason and thereby actuating the strap 6 which connects the person pushing to the locking means 3. Examples of such situations can be that the person pushing stumbles and falls, that the person pushing is unable to withstand the force of inertia on a steep downhill slope or down a flight of stairs, or when the person pushing leaves the baby carriage in the belief that the baby carriage will remain stationary, but it begins to roll in spite of this.

In this position, the person pushing actuates the locking means 3 with a force exceeding a predetermined threshold value in a direction away from the actuating means 10. A person pushing who falls, for example, will pull the locking means 3 out of its locking position. The locking means 3 thus ceases its engagement with the step 14. As a result, the locking means 3 ceases its locking of the first part 11 in the second position. The first part 11 will thus attempt to adopt its first position because it is no longer being acted upon by any external force. For example, the actuating means 10 can be spring-loaded so that the first part attempts to adopt the first position in the absence of external influence.

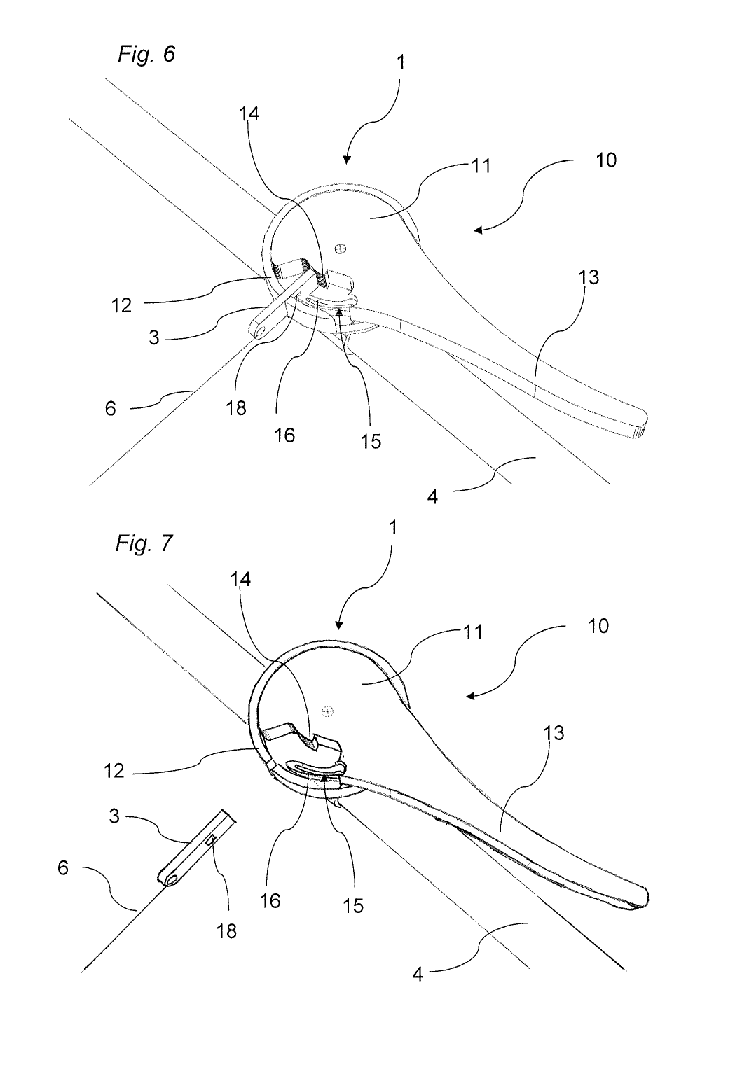

As depicted in FIG. 6, the locking means 3 no longer engages with the step 14. However, the retaining means 15 continues to engage with the recess 18 in the locking means 3. The resilient characteristics of the retaining means 15 permit the locking means 3 to cease its engagement with the first part 11, while the connection of the retaining means 15 to the locking means 3 is maintained. The retaining means 15 maintains its connection with the locking means 3 during displacement of the first part 11 from the second position to the first position. The retaining means 15 does not release the locking means 3 from the actuating means 10 until the first part 11 has adopted the first position.

In the depicted embodiment, the projection 16 maintains its engagement with the locking means 3 during the rotating movement until the first part 11 adopts the first position. Once the actuating means 10 has adopted its first position, the locking means 3 is released from the projection 16. As a result, the locking means 3 is also released from the actuating means 10. In this first position, as depicted in FIG. 6, the actuating means 10 actuates the brake arrangement 8 so that it adopts its braking state. Once the first part 11 has reached its first position, the baby carriage 2 is thus braked.

In the position depicted in FIG. 7, the baby carriage 2 is braked and the person pushing is released from the baby carriage.

The retaining means 15 acts as extra security in the sense that the locking means 3 is not released from the actuating means 10 until the first part 11 has reached its first position, in which the brake arrangement 8 is in its braking state. In the event that the first part 11 does not reach its first position, the locking means 3 is not released from the actuating means 10. Thus, the person pushing is also not released from the baby carriage 2, and the baby carriage 2 cannot run away out of control.

When the person pushing then wishes to release the brake arrangement 8 again, the person pushing once again turns the actuating means 10 to its second position and inserts the locking means 3 in accordance with what was previously described above with reference to FIGS. 2-4.

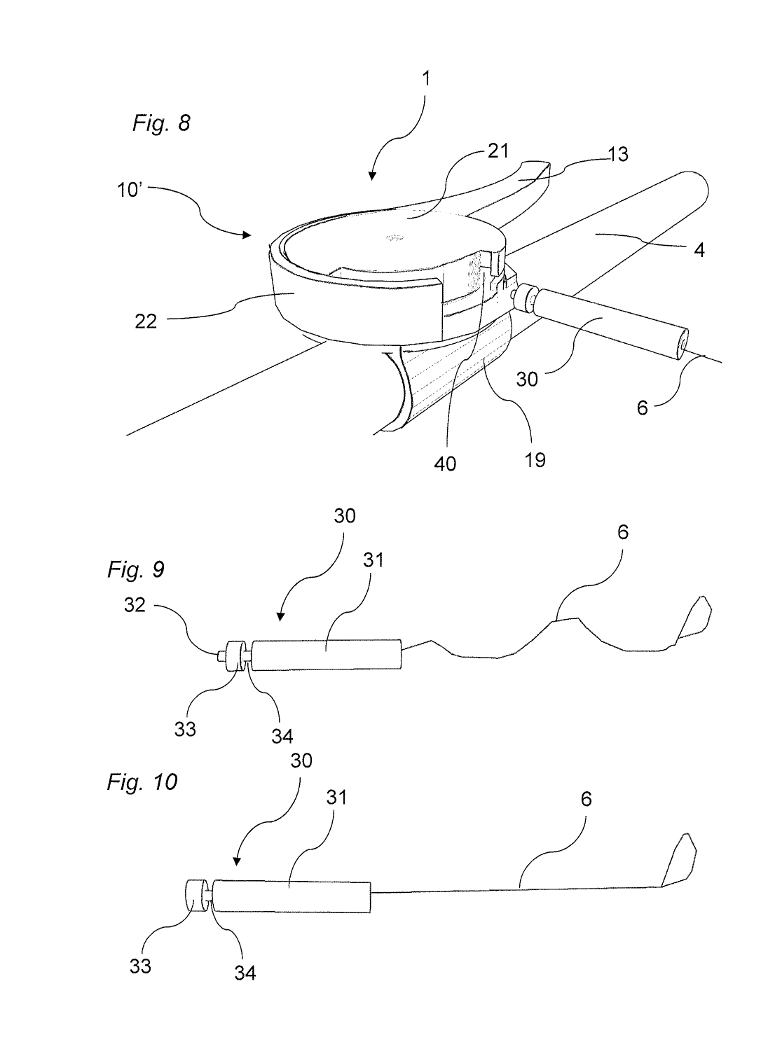

A second embodiment of the present invention is described with reference to FIGS. 8-14. Similarly to what has been described previously with reference to FIG. 1, a safety arrangement 1 is arranged on a chassis for a baby carriage 2 or the like. For example, the safety arrangement 1 can be arranged on a handle part of the baby carriage 2. In the manner described above, the safety arrangement 1 is connected to a brake arrangement in accordance with what has been described in conjunction with the first embodiment.

As previously, the safety arrangement 1 comprises an actuating means 10′ and a locking means 30. The actuating means 10′ can be attached, for example, to a handle part on the baby carriage by means of fixing means 19. A brake arrangement 8, which is arranged on the baby carriage 2, comprises brake elements which act upon one or more wheels of the baby carriage. Arranged between the brake arrangement 8 and the actuating means 10′ is a wire 7. Alternatively, the connection between the actuating means 10′ and the brake arrangement 8 can take place in some other way, for example by means of electrical transmission.

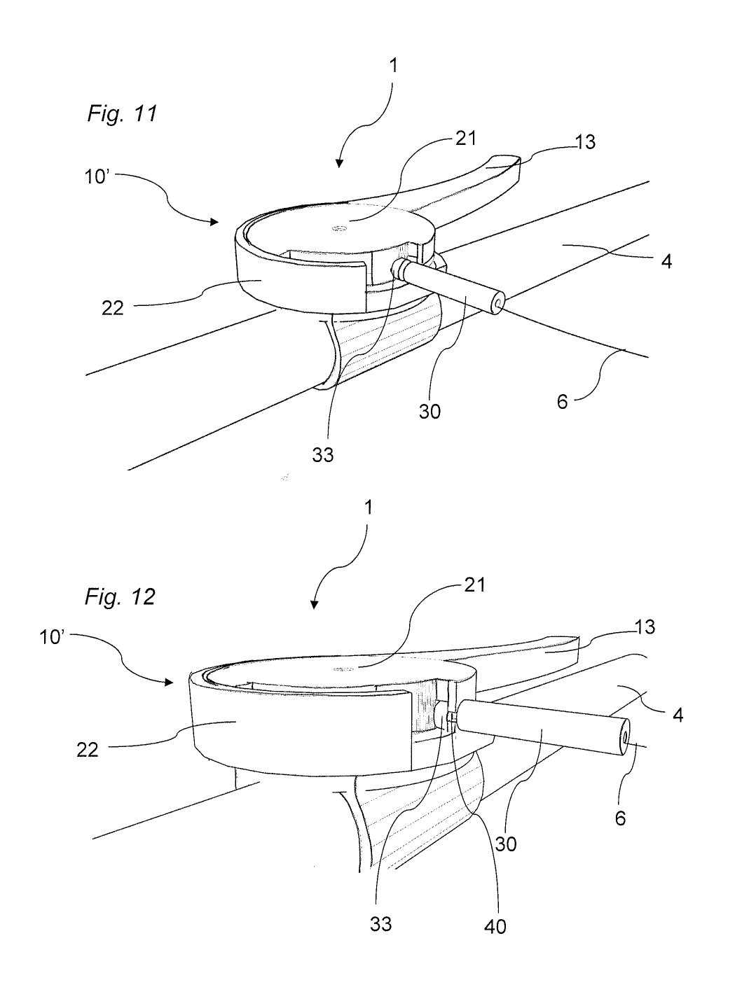

The locking means 30, which is illustrated in more detail in FIGS. 9 and 10, comprises in this embodiment a main body 31 and a pin 32 arranged at one end 33 of the locking means. The main body 31 has a circular cross section. The pin 32 projects from the main body 31. The pin 32 is displaceable between a projecting position, as depicted in FIG. 9, and a retracted position, as depicted in FIG. 10, in which the pin 32 is arranged inside the main body 31. The pin 32 is preferably resilient or spring-loaded and attempts to adopt its projecting position. The pin 32 is connected to a strap 6 which extends through the main body 31 and out through the other end of the locking means 30. The strap 6 is intended to connect the person pushing to the locking means 30. When the user pulls on the strap 6, the person pushing pulls on the pin 32 at the same time, so that the pin 32 reaches its retracted position. The main body 31 is further provided with a circumferential recess 34 arranged at a distance from the pin 32.

The actuating means 10′ comprises a first part 21 and a second part 22. The first part 21 is displaceable relative to the second part 22 between a first and a second position. More precisely, the first part 21 is rotatable relative to the second part 22 about a geometrical axis for displacement between the first and the second position. The actuating means 10′, in the first position of the first part 21, actuates the brake arrangement 8 so that it is in a braking state. In the second position of the first part 21, the actuating means 10′ actuates the brake arrangement 8 so that it is in a non-braking state. The first part 21 attempts to adopt the first position in the absence of external influence. For example, the actuating means 10′ can be spring-loaded so that the first part 21 attempts to adopt the first position.

The first part 21 is further provided with a handle part 13. The handle part 13 is so arranged as to facilitate rotation of the first part 21 from the first position to the second position.

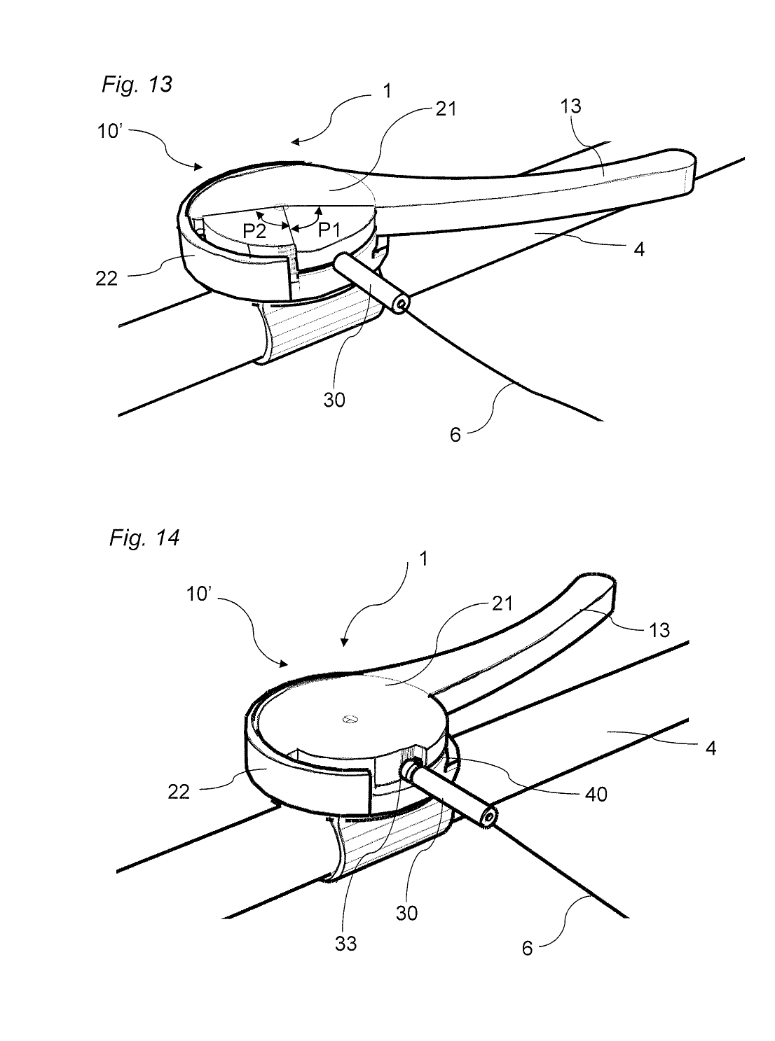

The first and the second part 21, 22 together define a groove 40. The groove 40 has a T-shaped cross section. The groove 40 extends all the way round a first part P1 of the circumference of the actuating means 10′ (see FIG. 13). This groove is not present in a second part P2 of the circumference of the actuating means 10′, said second part being separate from the first part. For example, the circumferential groove 40 can extend around one quarter of the circumference of the actuating means 10′, and the groove is not present on one quarter of the circumference of the actuating means 10′. The groove 40 is intended to receive one end 33 of the locking means 30. The circumferential recess 34 in the locking means 30 is intended to be arranged in the outer part of the groove 40, and the outer end 33 of the locking means 30 is intended to be arranged in the inner part of the groove 40. The geometry of the groove 40 is complementary to the geometry of the locking means 30, so that the locking means 30 is prevented from being pulled out of the groove 40 when the locking means 30 is fully inserted into the groove 40. The groove 40 thus functions as a retaining device.

Inside the part of the groove 40 which is defined by the first part 21, a recess (not shown) is arranged in the first part 21 in an angular position corresponding to the second position. The shape of the recess is complementary to the shape of the pin 32. For example, the recess may be in the form of a circular hole if the pin 32 has a circular cross section. The recess is intended to receive the pin 32 of the locking means 30 for locking the first part 21 in the first position.

The first part 21 and the second part 22 can be made of plastic. The handle part 13 and the locking means 30 can also be made of plastic.

The safety arrangement in accordance with this second embodiment will now be described with reference to FIGS. 11-14. In FIG. 11, to which reference is now made, the first part 21 of the actuating means 10′ is in its first position, in which the actuating means 10′ actuates the brake arrangement 8 so that it is in its braking state.

In order to permit displacement of the baby carriage 2, the person pushing moves the locking means 30 towards the actuating means 10′ and brings the locking means 30 into the groove 40 of the actuating means 10′. The pin 32, which is arranged at one end 33 of the locking means 30, will then be pressed into the main body 31 of the locking means 30. The person pushing takes hold of the handle part 13 and rotates the first part 21 of the actuating means 10′ towards the second position. The person pushing must then overcome the force which causes the first part 21 to attempt to adopt the first position.

Rotation of the first part 21, in a clockwise direction in the depicted embodiment, relative to the second part 22 will cause the locking means 30 to be arranged in the groove 40 which is formed by the first and the second part 21, 22. The engagement of the locking means 30 with the groove 40 is illustrated in FIG. 12. When the first part 21 has been rotated until the position of the locking means 30 corresponds to the position of the recess on the first part 21, the spring-loaded pin 32 will engage with the recess. The engagement of the pin 32 with the recess prevents further rotation of the first part 21 and locks the first part 21 in the second position, in which the brake arrangement 8 is in its non-braking state. The person pushing can now move the baby carriage 2 without being required to take hold of the handle part 13 in order to release the brake arrangement 8. This position is depicted in FIG. 13.

In a situation, in which the person pushing loses control of the baby carriage 2 for some reason, for example by falling, the person pushing will actuate the locking means 30 with a predetermined force in a direction away from the actuating means 10′. A person pushing who falls, for example, will actuate the strap 6, as a consequence of which the pin 32 of the locking means 30 will be pulled out of its engagement with the recess of the first part 21. As a result, the pin 32 ceases its locking of the first part 21 in the second position. The first part 21 will thus attempt to adopt its first position. This is because the first part 21 is no longer being acted upon by any external force.

However, the locking means 30 is still arranged in the groove 40 which is defined by the first and the second part 21, 22, as depicted in FIG. 13. The groove 40 thus functions as a retaining means and maintains its engagement with the locking means 30 until the first part 21 reaches the first position, in which the brake arrangement 8 adopts its braking state. Only when the first part 21 has been rotated to its first position does the locking means 30 move freely from the groove and is thus released from the actuating means 10′. The ability of the locking means 30 to move freely from the groove 40 denotes that the locking means 30 reaches that part of the actuating means 10′ which is not provided with any groove. This position is depicted in FIG. 14. The person pushing is now released from the baby carriage 2, and the brake arrangement 8 is in its braking state.

The retaining means in the form of the groove 40 acts as extra security because the locking means 30 is not released from the groove 40 until the first part 21 has reached the first position, in which the brake arrangement 8 is in its braking state. In the event that the first part 21 does not reach its first position, the locking means 30 maintains its engagement with the groove 40, and the locking means 3 is not released from the actuating means 10′. Thus, the person pushing is also not released from the baby carriage 2, and the baby carriage 2 cannot run away out of control.

When the person pushing then wishes to release the brake arrangement 8 again, the person pushing turns the actuating means 10′ once again to its second position and introduces the locking means 30 into the groove in accordance with what has previously been described above with reference to FIGS. 11-13.

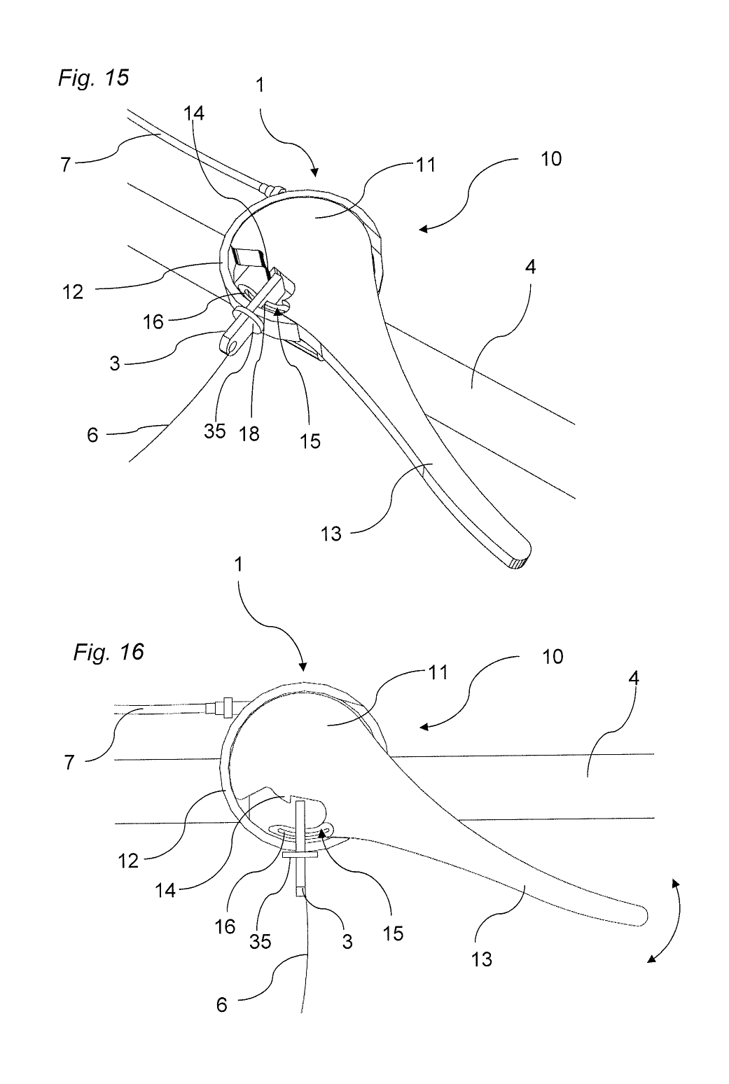

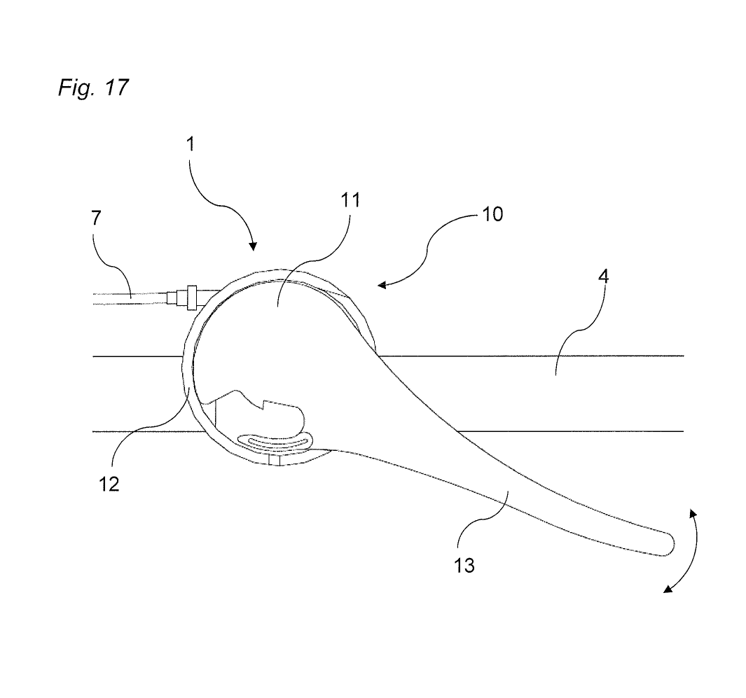

A further embodiment of the safety arrangement 1 will now be described with reference to FIGS. 15 and 16. Similarly to what has been described previously with reference to FIG. 1, a safety arrangement 1 is arranged on a chassis for a baby carriage 2 or the like. For example, the safety arrangement 1 can be arranged on a handle part of the baby carriage 2. In the manner described above, the safety arrangement 1 is connected to a brake arrangement 8 in accordance with what has been described in conjunction with the first embodiment.

In the third embodiment, the actuating means 10 is displaceable between the first position, in which the brake arrangement 8 is in a braking state, the second position, in which the brake arrangement 8 adopts its non-braking state, and a third position, in which said brake arrangement 8 or a further brake arrangement 8 adopts a braking state. The safety arrangement is of the type which has been described previously with reference to FIGS. 1-7, in consideration of which the description of the construction and function of the safety arrangement 1 is not repeated here.

FIG. 15 depicts the second position of the first part 11, in which the brake arrangement 8 adopts its non-braking state, corresponding to FIG. 4. The baby carriage 2 is able to move freely in this position. It may be desirable, however, to be able to brake the baby carriage a little in order to reduce the baby carriage speed. On downhill slopes, for example, it may be desirable to brake the baby carriage so that the speed of the baby carriage is reduced without the baby carriage being brought completely to a halt.

In the third embodiment, the first part 11 is displaceable relative to the second part 12 also between the second position and a third position. More precisely, the first part 11 is rotatable relative to the second part 12 about a geometrical axis for displacement between the second and the third position. The user can rotate the first part 11 by rotation of the handle part 13. In the third position, said brake arrangement, or a further brake arrangement associated with the third position, adopts a braking state.

The first, second and third positions of the first part 11 are arranged one after the other in a continuous rotational movement. The first part 11 reaches the second position by means of a rotational movement from the first position and reaches the third position by means of a further rotational movement from the second position. The rotational movement takes place in a clockwise direction in the depicted embodiment.

In the third position, the brake arrangement 8 adopts its braking state, in which brake elements are in engagement with at least one wheel. The third position can be constituted by an angular interval. Rotation of the first part 11 within this angular interval, which constitutes the third position, will cause the brake arrangement 8 to adopt its braking state. The brake arrangement 8 can provide a progressively increasing braking force on rotation of the first part 11 into the third position. FIG. 16 depicts the third position of the first part 11, in which the brake arrangement 8 adopts a braking state.

The safety arrangement 1 in its third position accordingly functions as a conventional handbrake for braking the baby carriage, for example on downhill slopes. The safety arrangement 1 thus provides a plurality of functions, such as the safety functions described above, together with a handbrake for use while pushing the baby carriage.

It will be appreciated that an arrangement which comprises an actuating means 10 without a locking means also constitutes an invention, as depicted in FIG. 17. The actuating means 10 is of the type described with reference to FIGS. 15 and 16. The actuating means 10 comprises a first part 11 and a second part 21, the first part 11 being displaceable relative to the second part 21 between a first position, a second position and a third position. The actuating means 10 is arranged, in the first position of the first part 11, to actuate a brake arrangement 8 in such a way that it is in a braking state, the actuating means, in the second position of the first part 11, being arranged to actuate the brake arrangement 8 so that it is in a non-braking state. The actuating means is arranged, in the third position of the first part 11, to actuate said brake arrangement 8 or a further brake arrangement in such a way that it is in a braking state. The first part 11 is arranged, in absence of external influence, to adopt the first position. The first part 11 is rotatable relative to the second part about a geometrical axis for displacement between the first, second and third positions.

The first, second and third positions of the first part 11 are arranged one after the other in a continuous rotational movement. The first part 11 reaches the second position by means of a rotational movement from the first position and reaches the third position by means of a further rotational movement from the second position. The rotational movement takes place in a clockwise direction in the depicted embodiment.

In the third position, the brake arrangement adopts its braking state, in which brake element is in engagement with at least one wheel. The third position can be constituted by an angular interval. Rotation of the first part 11 within this angular interval, which constitutes the third position, will cause the brake arrangement to adopt its braking state. The brake arrangement can provide a progressively increasing braking force on rotation of the first part 11 into the third position.

The user rotates the first part by means of the handle part 13 which is arranged on the first part. The first part 11 of the actuating means is rotated to its second position, in which the brake arrangement adopts a non-braking state. After a certain rotational movement, the first part 11 reaches its second position, in which the brake arrangement adopts a non-braking state. Because the first part 11 is arranged, in the absence of external influence, to adopt the first position, the user must apply a certain force in order to maintain the first part 11 in the second position and thus to be able to move the carriage. The first part 11 is displaceable between the second and the third position. If the user continues to rotate the first part 11 to the third position of the first part, the brake arrangement will adopt its braking state.

The arrangement is thus able to adopt the first position, in which the brake arrangement is in a braking state, the second position, in which the brake arrangement adopts its non-braking state, and the third position, in which said brake arrangement or a further brake arrangement adopts a braking state.

The arrangement can be provided with a catch for locking the first part in the second position. The catch can be in the form of a key or a button for locking the first part in the second position. The key can be so arranged as to cease said locking of the first part in the second position by application of a predetermined level of force.

A brake arrangement can achieve the braking action in both the first position and the third position of the safety arrangement as described with reference to FIGS. 15 and 16 and of the arrangement as described with reference to FIG. 17. A common brake arrangement can comprise a disc brake which is capable of achieving the braking action in the first position and the continuous braking in the third position.

Alternatively, a first brake arrangement can achieve the braking action in the first position, and a second brake arrangement can achieve the braking action in the third position of the safety arrangement as described with reference to FIGS. 15 and 16 and of the arrangement as described with reference to FIG. 17. The first brake arrangement can comprise, for example, a first brake element on a first wheel of the baby carriage. The first brake element can be a pin which is pushed into the wheel. The second brake arrangement can comprise, for example, a second brake element on a second wheel. The second brake arrangement can comprise, for example, an arrangement with brake blocks such as a rim brake or the like.

In FIGS. 15, 16 and 17, a wire 7 connects the brake arrangement to the actuating means. In the event that the safety arrangement comprises a first and second brake arrangement, the actuating means 10 can be connected to the first and second brake arrangement by means of one common wire 7, two separate wires or one branched wire. The wire 7 can be spring-loaded.

The locking means 3 in the embodiment in FIGS. 15 and 16 is provided with a collar 35. The collar 35 is arranged transversely relative the longitudinal extension of the locking means. When the locking means 3 is releasably attached to the actuating means 10 for locking the first part 11 in the second position, the collar 35 is arranged to bear against an outer area of the second part 12. A person skilled in the art will appreciate that such a locking means can also be used in the safety arrangement described with reference to FIGS. 1-7.

It will be appreciated that the embodiment of the safety arrangement 1 which is described with reference to FIGS. 8-14 can also be provided with the third position described above for the provision of a brake intended for use while pushing the baby carriage along.

The safety arrangement is described above in conjunction with a baby carriage. It will be appreciated that the safety arrangement according to the invention can also be used for other types of carriage, wheel chairs, rollator walking frames on wheels or the like. The safety arrangement can also be used for similar purposes on other types of vehicles and machines where it is desirable for the vehicle to be braked if the operator loses control of the vehicle. Examples of such arrangements include lawn mowers, snowmobiles, jet-skis, hand tools, processing machines, trains, boats, etc.

In the embodiment described with reference to FIGS. 8-14, the second part 22 exhibits a portion where the second part 22 does not enclose the first part 21. In an alternative embodiment, the second part 22 can also enclose the first part 21 in this area. In this case, the second part 22 has an opening, into which the locking means can be introduced for engagement with the actuating means and an opening for the handle part 13. Similarly to previously described embodiments, the first part 21 and the second part 22 do not form a groove in this area.

A plurality of modifications and variations are accordingly possible, for which reason the scope of the invention is thus defined exclusively by the accompanying claims. It will be appreciated, for example, that the first and the second part of the actuating means can have different relative positions, which can mean that the first part, which carries the handle part, radially encloses the second part.

1. A safety arrangement for a device) such as a baby carriage or a wheelchair, comprising an actuating means comprising a first part and a second part, the first part being displaceable relative to the second part between a first position and a second position, the actuating means being arranged, in the first position of the first part, to actuate a brake arrangement so that it is in a braking state, the actuating means being arranged, in the second position of the first part, to actuate the brake arrangement so that it is in a non-braking state, the first part being arranged, in absence of external influence, to adopt the first position,
a locking means being releasably attachable to the actuating means for locking the first part in the second position, the locking means being arranged to cease said locking of the first part in the second position by application of a predetermined force,
wherein the first part is rotatable relative to the second part about a geometrical axis for displacement between the first and the second position,
the actuating means including a retaining means which, upon releasable attachment of the locking means to the actuating means, is arranged to connect the locking means to the actuating means, the retaining means being arranged, by application of said predetermined force, to maintain the connection of the locking means to the actuating means until the first part has adopted the first position and then to release the locking means from the actuating means.

2. The safety arrangement as claimed in claim 1, wherein the second part comprises a section which is situated radially externally relative to the first part.

3. The safety arrangement as claimed in claim 1, wherein the locking means is arranged to engage with the first part for locking the first part in the second position.

4. The safety arrangement as claimed in claim 1, wherein the retaining means comprises a projection being arranged to engage with the locking means.

5. The safety arrangement as claimed in claim 1, wherein the retaining means is resilient.

6. The safety arrangement as claimed in claim 1, wherein the retaining means is arranged for guiding the locking means for locking the first part in the second position.

7. The safety arrangement as claimed in claim 1, wherein the first part comprises a step arranged to engage with the locking means for locking the first part in the second position.

8. The safety arrangement as claimed in claim 1, wherein the locking means comprises a pin arranged to engage with a recess in the actuating means for locking the first part in the second position.

9. The safety arrangement as claimed in claim 8, wherein the retaining means is formed by a groove which is defined by the first and the second part.

10. The safety arrangement as claimed in claim 8, wherein the pin is arranged, by application of said predetermined force, to cease its engagement with the recess in the actuating means.

11. The safety arrangement as claimed in claim 1, further comprising a strap arranged to be connected to the locking means and the person pushing the device.

12. The safety arrangement as claimed in claim 1, wherein the locking means is insertable into the actuating means in a radial direction.

13. The safety arrangement as claimed in claim 1, wherein said predetermined force is oriented in a radial direction away from the actuating means, and the magnitude of said force exceeds a predetermined threshold value.

14. The safety arrangement as claimed in claim 1, wherein one or other of the first and the second parts comprises a handle part being rotatable about said geometrical axis in order to bring the actuating means into the second position of the first part.

15. The safety arrangement as claimed in claim 1, further comprising a wire connected to the actuating means and the brake arrangement.

16. The safety arrangement as claimed in claim 1, wherein the actuating means is actuated by a spring force in order to cause the first part, in absence of external influence, to adopt the first position.

17. The safety arrangement as claimed in claim 1, wherein the first part is displaceable relative to the second part between said first position, said second position and a third position, the actuating means in the third position of the first part being arranged to actuate said brake arrangement or an additional brake arrangement so that the brake arrangement is in a braking state.

18. A baby carriage comprising a safety arrangement as claimed in claim 1.
